(19) United States
(12) Patent Application Publication
(10) Pub. No.: US 2025/0328590 A1
(43) Pub. Date: Oct. 23, 2025

(54) METHOD AND SYSTEM FOR PROVIDING MONITORING SERVICE FOR VIEWING HISTORY STORED IN ARTIST'S TERMINAL

(71) Applicant: WEVERSE COMPANY INC., Seongnam-si, Gyeonggi-do (KR)

(72) Inventor: Sang Il SIM, Seongnam-si, Gyeonggi-do (KR)

(73) Assignee: WEVERSE COMPANY INC., Seongnam-si, Gyeonggi-do (KR)

(21) Appl. No.: 18/873,267

(22) PCT Filed: Jun. 8, 2023
(86) PCT No.: PCT/KR2023/007884

§ 371 Date: Dec. 9, 2024

(30) Foreign Application Priority Data
Jun. 9, 2022 (KR) 10-2022-0070372

(51) Int. Cl. G06F 16/9535; G06F 16/9538

(52) U.S. Cl. CPC G06F 16/9535; G06F 16/9538

(57) ABSTRACT

The present disclosure relates to a method for providing a monitoring service for viewing history stored in an artist's terminal, the method including transmitting at least one action to a virtual number of the first artist terminal; executing the monitoring service that displays the history data stored in the first artist terminal; receiving the history data stored in the first artist terminal; detecting action data corresponding to the fan terminal among action data included in the received history data; and providing the history data including the detected action data according to a user's selection.

### TECHNICAL FIELD

The present disclosure relates to a method and system for providing a monitoring service for viewing history stored in an artist's terminal. More specifically, the present disclosure relates to a method and system for providing a monitoring service that allows fans to view history stored in an artist's terminal using their own individual terminals.

### BACKGROUND ART

A method for transmitting information between users using the Internet includes Instant Message Service (IMS) and Social Network Service (SNS).

Meanwhile, social networking services such as KakaoTalk, Twitter, and Instagram are widely used as channels for celebrities, such as entertainers and sports stars, to communicate with their fans.

However, the instant messaging service such as KakaoTalk is conducted in a one-to-many format. In the case of Twitter or Instagram, a message posted by one celebrity is displayed to multiple users in the same manner, so communication takes place in a way that multiple users read the same message.

Further, even if a fan replies to a message posted by a celebrity, the fan cannot confirm whether the celebrity actually read the reply he or she sent.

Furthermore, there is still a limitation that fans can only passively respond when there is a message from a celebrity, and that individual fans cannot initiate active communication.

### DETAILED DESCRIPTION OF INVENTION

### Technical Problems

According to one embodiment of the present disclosure, an objective of the present disclosure is to provide a method and system for providing a monitoring service for viewing history stored in an artist's terminal.

Further, the present disclosure is to provide a method and system for providing a monitoring service for viewing history stored in an artist's terminal, which provides the artist's contact record as content.

Further, the present disclosure is to provide a method and system for providing a monitoring service for viewing history stored in an artist's terminal, which conducts private/direct communication with fans based on the artist's phone number.

Further, the present disclosure is to provide a method and system for providing a monitoring service for viewing history stored in an artist's terminal, which allows content to be viewed by monitoring the artist terminal.

Further, the present disclosure is to provide a method and system for providing a monitoring service for viewing history stored in an artist's terminal, which virtually creates a contact record between a plurality of artists that suits the tastes of fans.

Further, the present disclosure is to provide a method and system for providing a monitoring service for viewing history stored in an artist's terminal, which detects a contact record exchanged between a user and an artist.

Further, the present disclosure is to provide a method and system for providing a monitoring service for viewing history stored in an artist's terminal, which allows a user to view records of other fans contacting an artist the user supports.

### Technical Solution

Among embodiments, a method for providing a monitoring service for viewing history stored in an artist's terminal may be a method for providing a monitoring service in which a fan terminal application executed by at least one processor of a fan terminal views history data stored in a terminal of a first artist, and may include transmitting at least one action to a virtual number of the first artist terminal; executing the monitoring service that displays the history data stored in the first artist terminal; receiving the history data stored in the first artist terminal; detecting action data corresponding to the fan terminal among action data included in the received history data; and providing the history data including the detected action data according to a user's selection.

The virtual number may be a telephone number of an artist's sub-terminal that is a subject of the monitoring service.

The action means at least one of a phone call, text message, and voice message sent by the fan terminal to the virtual number, and the action data is contact record data stored in the artist terminal according to the action of the fan terminal.

The providing the history data according to the user's selection may include viewing the history data of the first artist terminal by operating a predetermined application included in a screen based on a screen that displays the same screen as the screen of the first artist terminal on a display of the fan terminal.

The detecting the action data corresponding to the fan terminal among the action data included in the received history data may include detecting only action data corresponding to a unique phone number of the fan terminal from the action data stored in the first artist terminal according to actions performed on a plurality of fan terminals.

The received history data may include messenger data that stores content of action exchanged between the first artist terminal and the second artist terminal based on respective virtual numbers.

The providing the history data including the detected action data according to the user's selection may include executing a view of the contact record of the first artist; and controlling display of messenger data, which is a contact record with the second artist.

The received history data may include scenario content that is a virtual contact record between the first and third artists transmitted from the administrator terminal, and the providing the history data according to the user's selection may include executing a view of the contact record of the first artist; and controlling display of scenario content, which is a contact record with the third artist.

The received history data may further include artist content including at least one of an image, video, schedule, E-mail, playlist, and SNS subscription list generated according to the input of the first artist in the first artist terminal, and the providing the history data according to the user's selection may include executing a view of the image included in the artist content; and controlling a display of the image stored in the artist content.

The received history data may further include artist content including at least one of an image, video, schedule, E-mail, playlist, and SNS subscription list generated according to the input of the first artist in the first artist terminal, and the providing the history data according to the user's selection may include executing a view of the image included in the artist content; and controlling a display of the image stored in the artist content.

The detecting the action data corresponding to the fan terminal among the action data included in the received history data may include storing a first fan phone number of the first fan terminal; requesting action viewing permission with the stored first fan phone number; and adding the action data performed by the first fan terminal for the first artist terminal to the history data and providing it as a viewable monitoring service, when the request is accepted.

A system for providing a monitoring service for viewing history data stored in an artist's terminal may include at least one fan terminal with a fan terminal application installed; an artist sub-terminal with a registered virtual number; an administrator terminal in which an application for an administrator terminal is installed; and a monitoring service server that communicates with at least one fan terminal, artist sub-terminal, and administrator terminal using a network, wherein the fan terminal application performs at least one action with the virtual number of the first artist sub-terminal, executes an application that provides a monitoring service for the first artist sub-terminal, obtains history data stored in the first artist sub-terminal, and controls the display of the obtained history data according to the user's viewing input.

### Effect of Invention

The method and system for providing a monitoring service for viewing history stored in an artist's terminal according to an embodiment of the present disclosure have the effect of satisfying the needs of fans who want personal communication with artists by performing personal/direct communication with fans based on virtual numbers.

Further, the method and system for providing a monitoring service for viewing history stored in an artist's terminal according to an embodiment of the present disclosure have the effect of easily and quickly converting personal contact records that the artist wishes to make public into content by providing the artist's actual personal contact records as content, thereby increasing temporal/procedural efficiency.

Further, the method and system for providing a monitoring service for viewing history stored in an artist's terminal according to an embodiment of the present disclosure have the effect of providing an indirect experience for individual fans of peeking at an artist's mobile phone by monitoring the artist terminal to view content.

Further, the method and system for providing a monitoring service for viewing history stored in an artist's terminal according to an embodiment of the present disclosure have the effect of improving fan satisfaction with provided content by virtually creating a contact record between multiple artists that suits the tastes of fans.

Further, the method and system for providing a monitoring service for viewing history stored in an artist's terminal according to an embodiment of the present disclosure have the effect of increasing a fan's intimacy with an artist by providing an indirect experience as if privately interacting with the artist by detecting a contact record between the fan and the artist.

Further, the method and system for providing a monitoring service for viewing history stored in an artist's terminal according to an embodiment of the present disclosure have the effect of forming a bond between fans who support the same artist by allowing them to view records of other fans contacting them about the artist they support.

### BRIEF DESCRIPTION OF THE DRAWING

FIG. 1 is a conceptual diagram of a system that provides a monitoring service for viewing a history stored in an artist's terminal according to an embodiment of the present disclosure.

FIG. 2 is an internal block diagram of an artist main terminal according to an embodiment of the present disclosure.

FIG. 3 is a flowchart illustrating a method for generating private data according to an embodiment of the present disclosure.

FIG. 4 is an example showing a method for generating private data according to an embodiment of the present disclosure.

FIG. 5 is an example of private data generated in first and second artist sub-terminals according to an embodiment of the present disclosure.

FIG. 6 is a flowchart illustrating a method for generating messenger data according to an embodiment of the present disclosure.

FIG. 7 is a flowchart illustrating a method for detecting action data according to an embodiment of the present disclosure.

FIG. 8 is an example showing a method for detecting action data according to an embodiment of the present disclosure.

FIG. 9 is an example showing a method for generating filtering data according to an embodiment of the present disclosure.

FIG. 10 is an example showing a monitoring service provided to a fan terminal according to an embodiment of the present disclosure.

FIG. 11 is a flowchart illustrating a method in which a fan terminal monitors action data transmitted from another fan terminal according to an embodiment of the present disclosure.

### BEST MODE FOR CARRYING OUT THE INVENTION

Since the present disclosure may be changed in various ways and have various embodiments, specific embodiments are illustrated in the drawings and described in detail in the detailed description. The effects and features of the present disclosure and the method for achieving them will become clear with reference to the embodiments described in detail below together with the drawings. However, the present disclosure is not limited to the embodiments disclosed below and may be implemented in various forms. In the examples below, the terms “first”, “second”, etc. are not used in a limiting sense but are used for the purpose of distinguishing one component from another component. Also, singular expressions include plural expressions unless the context clearly indicates otherwise. Further, terms such as “include” or “have” imply the presence of features or components described in the specification, and do not preclude the possibility that one or more other features or components may be added. In addition, in the drawings, the sizes of components may be exaggerated or reduced for convenience of explanation. For example, the size and thickness of each component shown in the drawings are arbitrarily shown for convenience of explanation, so that the present disclosure is not necessarily limited thereto.

Hereinafter, embodiments of the present disclosure will be described in detail with reference to the accompanying drawings. When describing with reference to the drawings, identical or corresponding components are given the same drawing reference numerals and redundant descriptions thereof will be omitted.

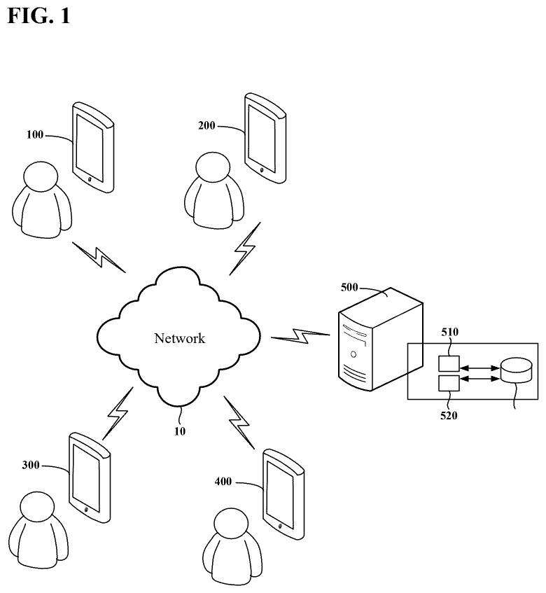

FIG. 1 is a conceptual diagram of a system that provides a monitoring service for viewing a history stored in an artist's terminal according to an embodiment of the present disclosure.

Referring to FIG. 1, the system providing the monitoring service for viewing the history stored in the artist's terminal according to an embodiment of the present disclosure may provide a service (hereinafter referred to as “monitoring service”) for viewing the history stored in the artist's terminal.

In an embodiment, the monitoring service is a service that allows viewing of history data including contact history content including records of communication between artists, other artists, and fans, artist content which is a record created solely by the artist, and scenario content which is virtually created in relation to the artist.

In an embodiment, the history data may refer to all records stored in the artist's terminal, and such history data may be generated to disclose artist's personal records to fans by exposing the history data stored in the artist's terminal according to an embodiment to another terminal.

Further, the fan may use his or her terminal to perform predetermined contacts (hereinafter referred to as “actions” in the embodiment) including making calls, sending text messages, and leaving voice messages to the artist's number.

Here, the artist's number may be a phone number created under the artist's name for the purpose of providing the monitoring service. Thus, the artist may have a previously used number and a number created separately for the monitoring service.

The artist terminal may include an artist main terminal registered with an existing number (hereinafter referred to as “Actual number”) and an artist sub-terminal registered with a number (hereinafter referred to as “Virtual number”) separately created for the monitoring service.

The monitoring service may be separately provided depending on a user using each terminal described below. Thus, an application for providing the monitoring service separately may be stored in each terminal, and processes performed in the stored applications may vary. In this case, the user may mean at least one of an artist, a fan, and an administrator.

In an embodiment, a system providing the monitoring service may include an artist main terminal 100, an artist sub-terminal 200, an administrator terminal 300, a fan terminal 400, a monitoring service providing server 500, and a network 10.

The artist main terminal 100 may be a personal smartphone that the artist has been previously using for personal purposes. The artist main terminal 100 may transmit personal contact records (e.g., call history and message history, etc.) or photos and videos captured by the artist to other terminals and/or servers for the purpose of the monitoring service.

The artist sub-terminal 200 may be a smartphone registered with the virtual number for the monitoring service and designed to appear as if it is the smartphone actually used by the artist.

The artist sub-terminal 200 may store data received from other terminals and/or servers, and may execute a series of processes for monitoring the stored data by a fan terminal 400.

An administrator terminal 300 may be a computing device that performs the role of managing, monitoring, and supervising predetermined content transmitted to the artist sub-terminal 200. Such an administrator terminal may be used for work purposes by at least one employee of a company to which the artist belongs, including a manager responsible for protecting the artist's privacy.

The fan terminal 400 may be a smartphone that performs a predetermined action on the artist sub-terminal 200 and monitors the artist sub-terminal 200. Such a fan terminal 400 may be the personal smartphone of the fan who has subscribed to the monitoring service for his or her favorite artist.

The artist main terminal 100, the artist sub terminal 200, the administrator terminal 300, the fan terminal 400, and the monitoring service providing server 500 may be connected via the network 10, and a dedicated application may be installed for each terminal to monitor the history data of the artist sub-terminal 200 and create, change, and delete the history data.

Here, the network 10 according to an embodiment means a connection structure that enables information exchange between nodes, such as the artist main terminal 100, the artist sub-terminal 200, the administrator terminal 300, the fan terminal 400, and the monitoring service providing server 500. Examples of the network 10 include, but are not limited to, a 3rd Generation Partnership Project (3GPP) network, a Long Term Evolution (LTE) network, a World Interoperability for Microwave Access (WIMAX) network, the Internet, a Local Area Network (LAN), a Wireless Local Area Network (Wireless LAN), a Wide Area Network (WAN), a Personal Area Network (PAN), a Bluetooth network, a satellite broadcasting network, an analog broadcasting network, a Digital Multimedia Broadcasting (DMB) network, etc.

Hereinafter, the artist main terminal 100, the artist sub-terminal 200, the administrator terminal 300, the fan terminal 400, and the monitoring service providing server 500, which implement a monitoring service providing system for providing the monitoring service, will be described in detail with reference to the accompanying drawings.

### Artist Main Terminal 100

The artist main terminal 100 according to an embodiment of the present disclosure may be a predetermined computing device in which a main terminal application for providing the monitoring service is installed.

In detail, from a hardware perspective, the artist main terminal 100 may be a mobile type computing device having the main terminal application installed to provide the monitoring service.

Here, the mobile type computing device may be a mobile device such as a smartphone or a tablet PC in which the application for providing the monitoring service is installed.

For example, the mobile type computing device may include a smartphones, a mobile phone, a digital broadcasting terminal, a personal digital assistant (PDA), a portable multimedia player (PMP), a tablet PC, etc.

Hereinafter, for convenience of explanation, the description will be based on the assumption that the artist main terminal 100 is the smartphone.

According to an embodiment, the artist main terminal 100 may further include a server computing device that provides a monitoring service environment.

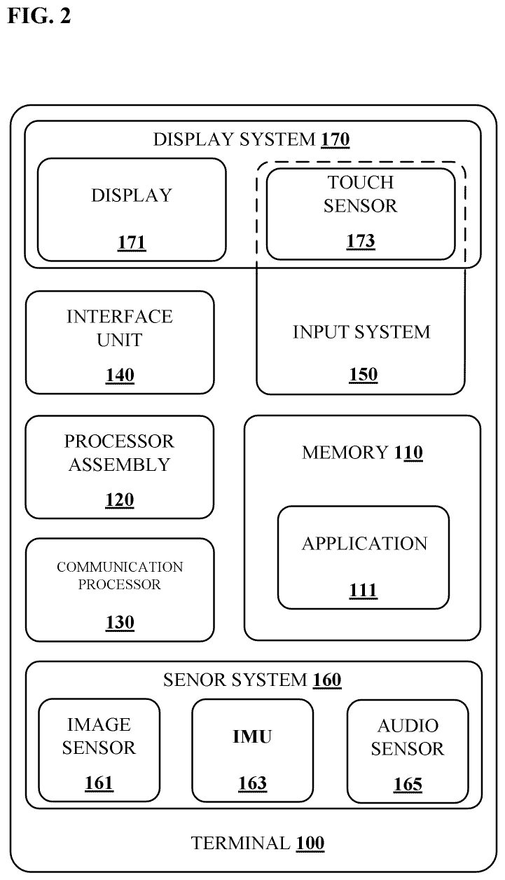

FIG. 2 is an internal block diagram of an artist main terminal according to an embodiment of the present disclosure.

Meanwhile, referring to FIG. 2, from a functional perspective, the artist main terminal 100 may include a memory 110, a processor assembly 120, a communication module 130, an interface module 140, an input system 150, a sensor system 160, and a display system 170. These components may be configured to be included within a housing of the artist main terminal 100.

In detail, an application 111 may be stored in the memory 110, and the application 111 may store one or more of various application programs, data, and commands for providing the monitoring service environment.

That is, the memory 110 may store instructions and data that may be used to create the monitoring service environment.

Further, the memory 110 may include a program area and a data area.

Here, according to an embodiment, the program area may be linked between an operating system (OS) and functional elements that boot the artist main terminal 100, while the data area may store data generated as the artist main terminal 100 is used.

Further, the memory 110 may include at least one non-transitory computer-readable storage medium and temporary computer-readable storage medium.

For example, the memory 110 may be various storage devices such as ROM, EPROM, flash drive, hard drive, etc., and may include a web storage that performs the storage function of the memory 110 on the Internet.

The processor assembly 120 may include at least one processor capable of executing instructions of the application 111 stored in the memory 110 to perform various tasks for creating the monitoring service environment.

In an embodiment, the processor assembly 120 may control the overall operation of the components through the application 111 of the memory 110 to provide the monitoring service.

Such a processor assembly 120 may be a system on chip (SOC) that is suitable for the artist main terminal 100 including a central processing unit (CPU) and/or a graphics processing unit (GPU), may execute the OS and/or application program stored in the memory 110, and may control each component mounted on the artist main terminal 100.

Further, the processor assembly 120 may communicate internally with each component via a system bus, and may include one or more predetermined bus structures including a local bus.

The processor assembly 120 may include at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and electrical units for performing other functions.

The communication module 130 may include one or more devices for communicating with external devices. The communication module 130 may perform communication via a wireless network.

In detail, the communication module 130 may communicate with a terminal that stores a content source for implementing the monitoring service environment, and may communicate with various user input components, such as a controller that receives user input.

In an embodiment, the communication module 130 may transmit and receive various pieces of data related to the monitoring service to and from other terminals and/or external servers.

The communication modules 130 may wirelessly transmit and receive data with at least one of a base station, an external terminal, and any server on a mobile communication network constructed through a communication device that may perform technical standards or communication methods for mobile communication (e.g., LTE (Long Term Evolution), LTE-A (Long Term Evolution-Advanced), 5G NR (New Radio), WIFI) or short-range communication methods.

The sensor system 160 may include various sensors such as an image sensor 161, a position sensor (IMU) 163, an audio sensor 165, a distance sensor, a proximity sensor, and a contact sensor.

Here, the image sensor 161 may capture images and/or videos of a physical space around the artist main terminal 100.

In an embodiment, the image sensor 161 may capture and acquire an image related to the monitoring service (e.g., a user image, etc.).

The image sensor 161 may be positioned on the front and/or rear of the artist main terminal 100 to capture an image of a direction it faces, and may capture a physical space through a camera oriented toward the outside of the artist main terminal 100.

Such an image sensor 161 may include an image sensor device and an image processing module. In detail, the image sensor 161 may process a still image or a moving image obtained by the image sensor device (e.g., CMOS or CCD).

In addition, the image sensor 161 may process the still image or the moving image acquired through the image sensor device using the image processing module to extract necessary information, and may transmit the extracted information to the processor.

Such an image sensor 161 may be a camera assembly including at least one camera. The camera assembly may include a general camera that captures an image in a visible light band, and may further include a specialized camera such as an infrared camera or a stereo camera.

According to an embodiment, the image sensor 161 may be included in the artist main terminal 100 to be operated, or may be included in the external device (e.g., external server, etc.) to be operated through linkage based on the communication module 130 and/or interface module 140.

The position sensor (IMU) 163 may detect at least one of the movement and acceleration of the artist main terminal 100. For example, it may be a combination of various position sensors such as an accelerometer, a gyroscope, and a magnetometer.

Further, the position sensor (IMU) 163 may recognize spatial information about the physical space around the artist main terminal 100 by linking with the position communication module 130 such as the GPS of the communication module 130.

The audio sensor 165 may recognize sound around the artist main terminal 100.

In detail, the audio sensor 165 may include a microphone capable of detecting voice input from the user using the artist main terminal 100.

In an embodiment, the audio sensor 165 may receive audio data required for the monitoring service from the user.

The interface module 140 may communicatively connect the artist main terminal 100 to one or more other devices. In detail, the interface module 140 may include wired and/or wireless communication devices compatible with one or more different communication protocols.

Through the interface module 140, the artist main terminal 100 may be connected to multiple input/output devices.

For example, the interface module 140 may be connected to an audio output device, such as a headset port or a speaker, to output audio.

Although the audio output device has been described as being connected via the interface module 140 as an example, it may be installed in the artist main terminal 100.

For example, the interface module 140 may be connected to an input device such as a keyboard and/or a mouse to obtain user input.

Although the keyboard and/or the mouse have been described as being connected via the interface module 140 as an example, they may be installed in the artist main terminal 100.

The interface module 140 may be configured to include at least one of a wired/wireless headset port, an external charger port, a wired/wireless data port, a memory card port, a port for connecting a device equipped with an identification module, an audio I/O (Input/Output) port, a video I/O (Input/Output) port, an earphone port, a power amplifier, an RF circuit, a transceiver, and other communication circuits.

The input system 150 may detect user input (e.g., a gesture, a voice command, the operation of a button, or another type of input) related to the monitoring service.

In detail, the input system 150 may include a predetermined button, a touch sensor, and/or an image sensor 161 that receives user motion input.

Further, the input system 150 may be connected to an external controller through the interface module 140 to receive user input.

The display system 170 may output various pieces of information related to the monitoring service as graphic images.

In an embodiment, the display system 170 may display a user interface (UI), content and/or content management system (CMS)-based data, etc.

Such a display may include at least one of a liquid crystal display (LCD), a thin film transistor-liquid crystal display (TFT LCD), an organic light-emitting diode (OLED), a flexible display, a 3D display, and an e-ink display.

The components may be disposed in the housing of the artist main terminal 100, and the user interface may include a touch sensor 173 on a display 171 configured to receive user touch input.

In detail, the display system 170 may include the display 171 that outputs an image and the touch sensor 173 that detects a user's touch input.

For example, the display 171 may be implemented as a touch screen by forming a mutual layer structure or being integrated with the touch sensor 173. This touch screen may function as a user input unit that provides an input interface between the artist main terminal 100 and the user, and simultaneously provide an output interface between the artist main terminal 100 and the user.

In an embodiment, the artist main terminal 100 may transmit and receive calls and text messages, etc., with at least one another user's terminal, and store a contact record.

Further, in an embodiment, the artist main terminal 100 may selectively transmit data including transmission and reception history, records, and contents with other terminals as contact record content that is a monitoring target of the monitoring service.

In an embodiment, the artist main terminal 100 may selectively transmit data including video, images, voice messages, etc. generated by the artist main terminal 100 itself as the contact record content that is the monitoring target of the monitoring service.

According to an embodiment, the artist main terminal 100 may further perform at least some of the functional operations performed by the monitoring service server 500 described below.

### Artist Sub-Terminal 200

The artist sub-terminal 200 according to an embodiment of the present disclosure may be a predetermined computing device in which an application for a sub-terminal is installed to provide the monitoring service.

From a hardware perspective, the artist sub-terminal 200 is the same mobile type computing device as the artist main terminal 100 described above, and is different from the artist main terminal in terms of only the process performed by the application. Thus, the same contents as described above will be omitted herein

In an embodiment, the artist sub-terminal 200 may be the terminal registered with the virtual number created for the monitoring service by the external server (e.g., telecommunications server).

The virtual number may be a number registered as a value-added information service provider designated by the telecommunications company after receiving a value-added telecommunications business registration.

The virtual number may be created for each member of the artist if the artist is a group.

Further, the artist sub-terminal 200 registered with the virtual number may be remotely controlled by another terminal (e.g., the artist main terminal 100 or the administrator terminal 300 and/or the server).

In an embodiment, the artist sub-terminal 200 may receive a predetermined action, including a phone call, text message, and voice message, from another terminal (e.g., fan terminal 400) based on the acquired virtual number.

Further, in an embodiment, the artist sub-terminal 200 may store multiple actions received from multiple fan terminals 400 by matching them with the fan terminals 400 that perform the actions, the phone numbers of the fan terminals 400, or the accounts of the fans.

In an embodiment, the artist sub-terminal 200 may detect a predetermined action to monitor only the contact record for the action performed from the corresponding fan terminal 400 when monitoring from the fan terminal 400.

In an embodiment, the artist sub-terminal 200 is described as a separate terminal independent from the artist main terminal 100.

However, the artist main terminal 100 and the sub-terminal 200 may not be separate independent terminals, but may be a single terminal in which the artist's existing phone number and the virtual number are registered at the same time. In this case, the artist terminal 100 may further install an application with a function to separately manage contact records, etc. for two numbers.

For example, the artist main terminal 100 may provide a first mode for managing the contact record for the existing artist's number, and a second mode for managing the contact records for the virtual number for the monitoring service.

### Administrator Terminal 300

The administrator terminal 300 according to an embodiment of the present disclosure may be a predetermined computing device in which an application for the administrator terminal for providing the monitoring service is installed.

From a hardware perspective, the administrator terminal 300 may include a mobile type computing device and/or a desktop type computing device in which the application providing the monitoring service is installed.

Here, the mobile type computing device may be a mobile device such as a smart phone or tablet PC in which the application providing the monitoring service is installed.

For example, the mobile type computing device may include a smart phone, a mobile phone, a digital broadcasting terminal, a personal digital assistant (PDA), a portable multimedia player (PMP), a tablet PC, etc.

Further, the desktop type computing device may include a device installed with a program for executing the monitoring service based on wired/wireless communication, such as a fixed desktop PC, a laptop computer, or a personal computer such as an ultrabook, in which the application providing the monitoring service is installed.

For convenience of explanation, it may be described based on the fact that the administrator terminal 300 is a smartphone. Thus, from a hardware perspective, the administrator terminal 300 is the same mobile type computing device as the above-described artist main terminal 100, and, and is different from the artist main terminal in terms of only the process performed by the application. Thus, the same contents as described above will be omitted herein.

In an embodiment, when the administrator terminal 300 receives a prohibited action including profanity and obscene material among predetermined actions received from at least one fan terminal 400 to the artist sub-terminal 200, the administrator terminal 300 may delete the action from the contact record for the virtual number.

Further, in an embodiment, the administrator terminal 300 may receive and check the contact record with other terminals, or the photos and videos taken by the artist through the sub-terminal 200 before they are exposed through the monitoring service, and manage whether or not they are exposed or perform modifications and editing, etc.

In an embodiment, the administrator terminal 300 may receive predetermined data transmitted from the artist main terminal 100 to the artist sub-terminal 200 before it is generated as history data exposed through the monitoring service of the artist sub-terminal 200, and manage whether to expose it or perform modification, editing, etc.

Further, in an embodiment, the administrator terminal 300 may determine whether to register the acquired predetermined data as the history data in the artist sub-terminal 200 (e.g., hold for a predetermined period of time, permit reception, cancel reception, etc.).

This is to prevent private data containing sensitive information that the artist should not disclose from being exposed to the artist sub-terminal 200, thereby preventing sensitive information related to the artist from being revealed.

### Fan Terminal 400

The fan terminal 400 according to an embodiment of the present disclosure may be a predetermined computing device in which an application for the fan terminal for providing the monitoring service is installed.

From a hardware perspective, the fan terminal 400 is the same mobile type computing device as the above-described artist main terminal 100, and is different from the artist main terminal in terms of only the process performed by the application. Thus, the same contents as described above will be omitted herein.

In an embodiment, the fan terminal 400 may perform a predetermined action, including phone calls, text messages, and voice messages, through the virtual number of the artist sub-terminal 200. At this time, the predetermined action may be performed through a pre-installed application (e.g., a phone and message application pre-installed in a mobile phone) that performs a function for each action, rather than an application for the monitoring service of the fan terminal 400.

At this time, an external server (e.g., telecommunications server) may charge the fan terminal 400 for a predetermined action performed on the fan terminal 400 and transmitted to the artist sub-terminal 200.

Further, in an embodiment, the fan terminal 400 may generate action data including the above-described performed action.

In an embodiment, the fan terminal 400 may detect only action data created by itself among at least one action data included in the contact record content.

Further, in an embodiment, the fan terminal 400 may view action data generated by another fan terminal 400 among at least one action included in the contact record content, with the permission of another fan terminal 400.

In an embodiment, the fan terminal 400 may monitor history data in the artist sub-terminal 200 on the basis of a monitoring application that provides the monitoring service.

In detail, in an embodiment, the fan terminal 400 may monitor contact record content, artist content, and scenario content stored in the artist sub-terminal 200 on the basis of the monitoring application that provides the monitoring service.

In an embodiment, monitoring may refer to the overall act of checking, viewing, playing, and listening to the contents of data stored in the artist sub-terminal 200.

For instance, in an embodiment, the fan terminal 400 may check a schedule stored in the artist sub-terminal 200, view and play predetermined content including photos and videos, play and listen to a music playlist, and view text and email content.

### Monitoring Service Server 500

Meanwhile, the monitoring service server 500 according to an embodiment of the present disclosure may perform a series of processes to provide the monitoring service to the fan terminal 400.

In detail, in an embodiment, the monitoring service server 500 may provide the monitoring service to the fan terminal 400 by exchanging data required to provide the monitoring service to the fan terminal 400 between multiple terminals, such as the artist main terminal 100, the artist sub-terminal 200, the administrator terminal 300, and the fan terminal 400 and driving a predetermined process for the monitoring service in each terminal.

In more detail, in an embodiment, the monitoring service server 500 may provide an environment in which applications may operate on the plurality of terminals (in the embodiment, the artist main terminal 100, the artist sub-terminal 200, the administrator terminal 300, and the fan terminal 400).

To this end, the monitoring service server 500 may include application programs, data and/or commands for operating a dedicated application installed in each of the terminals, and may transceive data based thereon between the plurality of terminals.

Further, in an embodiment, the monitoring service server 500 may execute a series of processes to provide the monitoring service to each of the terminals.

In detail, in an embodiment, the monitoring service server 500 may execute a process of generating at least one data generated based on the plurality of terminals as the history data, and a process of transmitting the generated history data to the fan terminal application.

Further, in an embodiment, the monitoring service server 500 may execute a search process to search for a predetermined actual number and virtual number among the actual numbers and virtual numbers of multiple artists stored in a database of the monitoring service server 500.

In an embodiment, the monitoring service server 500 may execute a search process to search for data on a predetermined artist among a plurality of pieces of data stored in the database of the monitoring service server 500.

In an embodiment, the monitoring service server 500 may provide various pieces of data generated based on at least one process described above to the fan terminal 400.

Further, in an embodiment, the monitoring service server 500 may perform user-customized deep learning model learning.

In detail, in an embodiment, the monitoring service server 500 may perform deep learning required for the monitoring service in conjunction with a predetermined deep learning model.

In more detail, in an embodiment, the monitoring service server 500 may read out a predetermined deep neural network driving program constructed to perform the deep learning from a communication module 530 and perform the deep learning described below according to the read-out predetermined deep neural network system.

Here, the deep learning model according to the embodiment may include a STT (Speech-to-text) deep learning model, a Speech recognition deep learning model, an HMM (Hidden Markov Model)-based deep learning model, and/or an LSTM (Long Short-Term Memory)-based deep learning model.

At this time, depending on an embodiment, the deep learning model may be directly included in the monitoring service server 500 or implemented as a device and/or server separate from the monitoring service server 500 to perform deep learning for the monitoring service.

In the following description, the deep learning model is described as being included in the monitoring service server 500, but is not limited thereto.

Further, in an embodiment, the monitoring service server 500 may train the deep learning model as the customized deep learning model optimized for the characteristics of each user (in an embodiment, the user's pronunciation characteristics, etc.).

Further, in an embodiment, the monitoring service server 500 may store and manage various application programs, commands and/or data to implement the monitoring service.

As an embodiment, the monitoring service server 500 may store and manage predetermined content formed from at least one terminal, predetermined user (e.g., artist and fan) response data, and/or a predetermined deep learning model.

Referring further to FIG. 1, in an embodiment, the monitoring service server 500 may be implemented as a predetermined computing device including at least one processor module 510 for data processing, at least one communication module 520 for data exchange with an external device, and at least one memory module 530 for storing various application programs, data, and/or commands for providing the monitoring service.

Here, the memory module 530 may store at least one of the OS, various application programs, data, and commands for providing the monitoring service.

Further, the memory module 530 may include a program area and a data area.

Here, according to an embodiment, the program area may be linked between the OS and functional elements that boot the server, while the data area may store data generated as the server is used.

In an embodiment, the contact record content including private data, messenger data, and action data and data including scenario content and artist content may be stored in the memory module 530.

Further, in an embodiment, the memory module 530 may store artist information including the artist's name, artist's group name, artist's agency name, etc. of at least one artist who has subscribed to the monitoring service.

Further, in an embodiment, the memory module 530 may store the actual number and virtual number of a corresponding artist by matching them with the artist information.

In an embodiment, the memory module 530 may be various storage devices such as ROM, RAM, EPROM, flash drive, or hard drive, and may also be web storage that performs the storage function of the memory module 530 on the Internet.

Further, the memory module 530 may be a removable recording medium on the server.

The processor module 510 may control the overall operation of each unit so as to implement the monitoring service.

In an embodiment, the processor module 510 may control the overall operation of each unit described above to provide data on at least one of the contact record content, scenario content, and artist content including private data, messenger data, and action data stored in the memory module 530 as history data to the fan terminal 400.

Such a processor module 510 may be a system on chip (SOC) that is suitable for the server including a central processing unit (CPU) and/or a graphics processing unit (GPU), may execute the OS and/or application program stored in the communication module 30, and may control each component mounted on the server.

Further, the processor module 510 may communicate internally with each component via a system bus, and may include one or more predetermined bus structures including a local bus.

The processor module 510 may include at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and electrical units for performing other functions.

Although it has been described that the monitoring service server 500 according to an embodiment of the present disclosure performs the above-described functional operations, at least some of the functional operations performed by the monitoring service server 500 may be performed by other terminals (in an embodiment, the artist main terminal 100, the artist sub-terminal 200, the administrator terminal 300, and the fan terminal 400), and at least some of the functional operations performed by other terminals may be further performed by the monitoring service server 500, depending on an embodiment.

### Method of Managing Monitoring Content by Artist Sub-Terminal 200

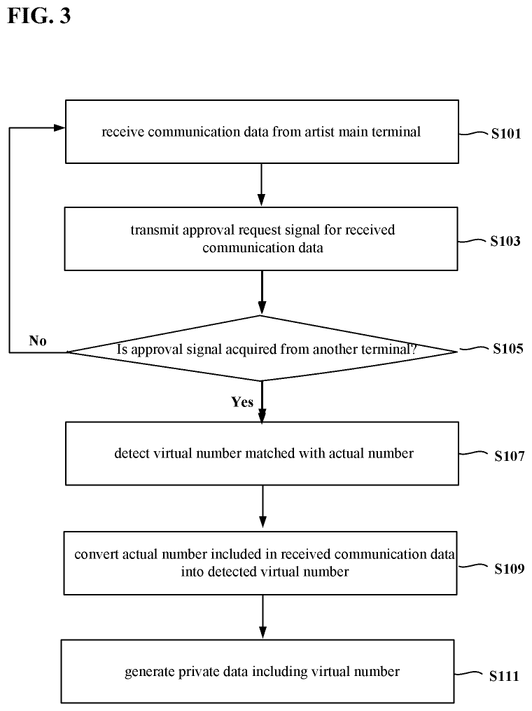

Hereinafter, a method of managing the monitoring content so that the sub-terminal application of the artist sub-terminal 200 provides the monitoring service to the fan terminal 400 according to an embodiment of the present disclosure will be described in detail with reference to FIGS. 3 to 6.

In an embodiment of the present disclosure, at least one processor of the artist sub-terminal 200 may execute at least one sub-terminal application stored in the memory of at least one artist sub-terminal 200 or operate it in the background.

Hereinafter, the method of providing the above-described monitoring service by having at least one processor of the artist sub-terminal 200 operate to execute commands of the at least one sub-terminal application will be briefly described as being performed by the artist sub-terminal 200.

In an embodiment, the artist sub-terminal 200 may check a predetermined action performed on the artist sub-terminal 200 or artist virtual number at the fan terminal 400 and provide feedback to the fan terminal 400.

To this end, in an embodiment, the artist sub-terminal 200 may receive at least one action performed at the plurality of fan terminals 400.

In detail, in an embodiment, the artist sub-terminal 200 may receive actions including at least one phone call, text message, voice message, etc. performed on multiple fan terminals 400 for the virtual number of the artist sub-terminal 200 and/or an SNS account created through the virtual number. Hereinafter, the virtual number and the SNS account registered with the virtual number will be described using the virtual number.

At this time, the virtual number of the artist sub-terminal 200 may be provided to the fan terminal 400 when the fan, who is the user of the fan terminal 400, subscribes to the monitoring service for the artist he or she supports. Here, the artist may be given the virtual number for the monitoring service separately from the actual number of the artist main terminal 100 that he/she uses privately. This description is based on an embodiment having the artist sub-terminal 200 for managing such a virtual number.

For example, a first artist sub-terminal may be the artist sub-terminal 200 used by “Artist A.”

Multiple fans who have subscribed to the monitoring service for “Artist A” on a monitoring service platform may perform a certain action and transmit it through the first virtual number of the first artist sub-terminal using their respective fan terminals 400. Thus, in the embodiment, the first artist sub-terminal may receive at least one action performed by the multiple fan terminals 400 and check the received action.

Further, in an embodiment, the artist sub-terminal 200 may provide feedback for at least one of the above actions or for at least one fan terminal 400 on which the action is performed. Here, the feedback may include at least one phone call, text message, voice message, etc.

That is, the artist sub-terminal 200 may perform functions such as voice calls, sending and receiving text messages, and sending and receiving SNS messages for the virtual number, just like a general mobile phone. Hereinafter, the main functions of the sub-terminal application for the artist to efficiently check and respond to actions performed by multiple fan terminals on the artist sub-terminal 200 will be described.

In detail, in an embodiment, the artist sub-terminal 200 may provide feedback by transmitting at least one of data pre-stored in the memory of the artist sub-terminal 200 and/or response data formed in real time in the artist sub-terminal 200 to at least one fan terminal 400 on which the action has been performed.

At this time, the actions performed on the multiple fan terminals 400 may include 1) making a phone call and 2) sending a text message.

The action may include the entire act of transmitting a predetermined data to the virtual number of the artist sub-terminal 200. For convenience of explanation, only the cases of making a phone call and sending a text message are given as examples.

In an embodiment, the artist sub-terminal 200 may perform a real-time phone call to a specific fan terminal 400 when 1) a phone call is made from at least one fan terminal 400. In addition, data including a voice message recorded in the actual artist's voice among the data pre-stored in the artist sub-terminal 200 may be provided to the plurality of fan terminals 400.

In detail, the artist sub-terminal 200 may store and set a missed call notification message that is output when a phone call from the fan terminal 400 is not received, based on voice input from the artist.

Subsequently, when the fan terminal 400 makes a call to the virtual number and a predetermined amount of time elapses, the preset missed call notification message may be output.

The fan terminal 400 may leave a missed voice message after listening to the missed call notification message, depending on whether to leave the missed voice message.

Further, the artist sub-terminal 200 may check and play missed voice messages that are matched to the number of the fan terminal 400 or the monitoring service subscription account.

The artist sub-terminal 200 may store the data in the server or memory so that the plurality of fan terminals 400 may check and play back a plurality of missed call records and a plurality of missed voice messages made through the virtual number over a predetermined period of time.

Here, the predetermined period of time may mean the period from the time the artist last checks the action of the fan terminal 400 to a current viewing time. Alternatively, it may mean the period from the time the artist last checks missed calls and messages during the action of the fan terminal 400 to the current viewing time.

At this time, the artist sub-terminal 200 may continuously play multiple missed voice messages recorded over a predetermined period of time so that the multiple missed voice messages may be quickly checked, and may provide an additional function such as changing a playback speed.

The artist sub-terminal 200 may provide the artist with the ability to quickly check missed voice messages as text by sequentially listing and displaying missed text messages converted into messages through Speech-to-Text (STT) of multiple missed voice messages.

The artist sub-terminal 200 may filter and delete missed voice messages containing prohibited words, such as profanity and slang, after converting the multiple missed voice messages into text.

The artist sub-terminal 200 may provide a blocking mode to temporarily block reception alarms of actions performed by fans or through unsaved numbers/accounts, because actions with other artists or acquaintances may be difficult as actions are received from the fan terminals 400.

For example, when the blocking mode is executed, the artist may filter only actions based on the numbers of other artists or families stored in the artist sub-terminal 400 and display alarms and received content through the artist sub-terminal 400, thereby smoothly recording desired others and history data as the monitoring content.

The actions of the fan terminal 400 during the blocking-mode execution time may be received as the contact record after the blocking mode is released.

Since it is difficult to create the monitoring content when the artist continuously receives actions such as phone calls and text messages from an unspecified number of people in the process of creating the monitoring content based on the contact record between actual artists and registered acquaintances, the blocking mode may be provided so that actions are received but alarms or records of action reception are not output for a while.

Therefore, in the blocking mode, the artist sub-terminal 200 may output only reception alarms for phone numbers and/or SNS accounts pre-stored in the memory.

Meanwhile, the artist sub-terminal 200 may leave a missed voice message to multiple fans at once.

For example, the artist sub-terminal 200 may be targeted at multiple fans, such as fans who have left a missed voice message for a predetermined period of time or all fans who have subscribed to the artist monitoring service, and then transmit a feedback voice message created by recording the voice to each fan terminal 400 so that it may be checked as a missed voice message.

That is, through the monitoring service, the artist may create the missed voice message or the missed voice text message in batches and send it to multiple fan terminals 400 set as targets, rather than calling the number of each fan terminal 400 and leaving the missed voice message.

At this time, the artist sub-terminal 200 or server may convert at least a part of the artist's missed voice into the personal information of the fan who will receive it and then leave it as the fan's missed voice.

For example, when the artist speaks a nickname replacement setting code corresponding to the fan's nickname in the missed voice, an artificial intelligence voice generation algorithm may be used to generate the artist's voice for the fan's nickname using the artist's voice as base data, and a missed voice customized for the fan may be created by replacing a voice section of a nickname replacement setting code.

That is, the artist sub-terminal 200 may provide a missed voice message transmission function that may create and leave a missed voice individually customized to multiple fans.

For example, when 2) the text message is sent from at least one fan terminal 400, the artist sub-terminal 200 may receive and confirm the text message by matching it to the registered number of the fan terminal 200 or the monitoring service subscription account.

The artist sub-terminal 200 may provide data including a message entered by an actual artist among the data pre-stored in the artist sub-terminal 200 to the fan terminals 400.

In an embodiment, the artist sub-terminal 200 may set automatic transmission by determining the contents of a reservation message according to conditions when conditions such as a specific message or event from the fan are satisfied based on the artist's input.

For example, the artist sub-terminal 200 may be set to automatically send a congratulatory message when signing up for the artist monitoring service, may be set to automatically send a reply message to a first text message from the fan after signing up, and may be set to automatically send a reservation message on the fan's individual event anniversary, such as the fan's birthday or the 1st anniversary of signing up for the service.

Further, the artist sub-terminal 200 may send a text message to multiple fans at once.

For example, the artist sub-terminal 200 may be targeted at multiple fans, such as automatically set and targeted at fans who have left a text message for a predetermined period of time or targeted at all fans who have subscribed to the artist monitoring service, and then create a text message to be sent to the designated multiple fans and send it to each fan terminal 400. Here, the predetermined period of time may mean the period from the time the artist last checked the action of the fan terminal 400 to the current viewing time.

In an embodiment, the artist sub-terminal 200 may individually customize and send the text message to multiple fans.

To this end, the fan may preset a nickname to use when signing up for an application that provides the monitoring service based on the fan terminal 400.

When the artist writes and sends a message including a predetermined nickname replacement setting code based on the artist sub-terminal 200, the nickname replacement setting code may be automatically converted by the server into a preset nickname for each fan and transmitted to each fan terminal 400.

That is, in an embodiment, when the artist sub-terminal 200 sends the text message to the fan terminal 400, a predetermined nickname replacement setting code included in the text message may be changed to a nickname set by a user, and then a personalized text message for each fan may be provided to the fan terminal 400.

Further, in an embodiment, the artist sub-terminal 200 may generate a read mark for a record based on accumulated actions from the fan terminals 400 when the artist executes an application that provides the monitoring service, when actions are confirmed through the artist sub-terminal 200, and/or at a specified time.

For instance, the artist sub-terminal 200 may generate a read mark for all messages previously received from the multiple fan terminals 400 based on the time at which the application is executed on the artist sub-terminal 200.

Further, in an embodiment, the artist sub-terminal 200 may provide real-time response data for a predetermined action performed on at least one fan terminal 400 to the fan terminal 400.

For example, the artist may select a predetermined action from among all actions received based on the artist sub-terminal 200 and perform actions such as replying to a message and sending a voice message.

Thus, the artist sub-terminal 200 may generate real-time response data and provide the real-time response data to the fan terminal 400 that performs the selected action.

Further, in an embodiment, the artist sub-terminal 200 may provide a video call notification screen to at least one fan terminal 400 that has performed a predetermined action during a video fan meeting.

The video call notification screen may include the virtual number assigned to the artist sub-terminal 200, and may be individually provided to at least one fan terminal 400.

Further, the artist sub-terminal 200 may perform a video call with at least one fan among the fans who have subscribed to the monitoring service.

When conducting the video call with multiple fans, the artist sub-terminal 200 may transmit real-time video and/or audio captured by the artist sub-terminal 200 to the multiple fan terminals 400, thereby providing the feeling of conducting a video call with the artist personally.

The artist sub-terminal 200 may receive and output video and audio captured from the multiple fan terminals 400. At this time, real-time images captured from the multiple fan terminals 400 may be displayed on multiple split screens, and real-time audio may be selectively output from only one of the multiple fans, and a highlight may be displayed on the real-time image corresponding to the fan that is output, allowing the artist to identify the fan whose audio is being output.

Thus, in an embodiment, the artist sub-terminal 200 may provide an effect as if the artist made a private video call on the fan terminal 400 where the video call notification screen is exposed.

In this way, the artist sub-terminal 200 according to the embodiment of the present disclosure provides feedback on the action performed at the fan terminal 400, thereby providing the effect of the artist actually checking the fan's message and satisfying the needs of fans who want personal communication with the artist.

Further, in an embodiment, the artist sub-terminal 200 may create and store contact record content included in the history data and provide it for confirmation on the fan terminal 400 through the monitoring service.

In an embodiment, the contact record content refers to content that includes records of the artist contacting others using the artist main terminal 100 and/or the artist sub-terminal (200), and may include private data, messenger data, and action data.

At this time, the action data may include data generated by contacting the artist from the fan terminal 400, and may include data generated by the artist contacting the fan terminal 400 via the virtual number.

Further, in an embodiment, the private data may mean data that the artist has chosen to provide as the monitoring service at least part of records of personal contact with other terminals based on the actual number of the artist main terminal 100.

Further, in an embodiment, the messenger data may mean data including the record of at least two artists contacting each other based on the virtual number of each artist sub-terminal 200.

That is, in an embodiment, the artist sub-terminal 200 may generate and store the private data and the messenger data included in the contact record content.

Such private data and messenger data may be text, image and video data including call start and end times, call recipient name, call recording audio files, message/messenger receiving and sending times, message/messenger conversation content, message/messenger recipient name, etc.

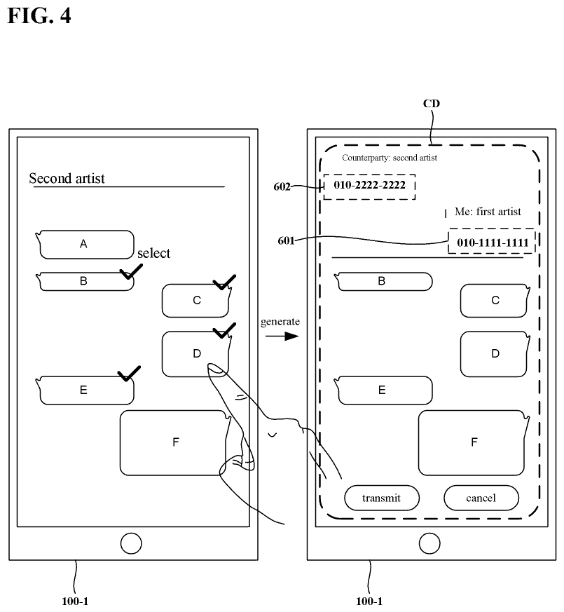

FIGS. 3 and 4 are diagrams for explaining the private data according to an embodiment of the present disclosure.

In detail, FIG. 3 is a flowchart illustrating a method for generating the private data according to an embodiment of the present disclosure, and FIG. 4 is an example showing a method for generating the private data according to an embodiment of the present disclosure.

In an embodiment, the private data may be generated based on communication data including a predetermined action transmitted and received by the artist using the actual number of the artist main terminal 100.

In an embodiment, the communication data may be data including at least one of the content of the action, the storage name and actual number of a sender and receiver who exchange the action.

Referring to FIG. 3, in an embodiment, the artist sub-terminal 200 may receive communication data from the artist main terminal 100 at step S101.

In detail, in an embodiment, the artist sub-terminal 200 may receive communication data including a predetermined action selected by the artist from among actions transmitted and received by the artist with a user of another terminal based on the actual number or an account according to the actual number from the artist main terminal 100.

In an embodiment, the user of another terminal may be an actual acquaintance (ordinary people) of the artist and other artists. However, for convenience of explanation, the user of another terminal may be other artists, so that the explanation will be based on the assumption that another terminal is the main terminal of the artist.

In other words, in an embodiment, the artist sub-terminal 200 may receive communication data including a predetermined action selected by the artist from among the actions transmitted and received by a first artist and a second artist based on their respective actual numbers from the first artist main terminal.

To this end, in an embodiment, the first artist may select a predetermined action from among all actions performed by the second artist using their respective actual numbers based on the first artist main terminal 100-1.

The selected actions may be actions that include text, captured images, recorded videos, etc. containing content that the first artist wishes to disclose to fans.

Referring to FIG. 4, for example, the first artist may select a predetermined message from among all messages (message boxes A to F in FIG. 4) exchanged with the second artist on the first artist main terminal 100-1.

Based on the example shown, the message boxes A, B and E are messages received from the second artist, and the message boxes C, D and F are messages received by the first artist from the second artist.

For example, the first artist may perform a user input to select the message boxes B, C, D and E among the message boxes A to F based on the first artist main terminal 100-1.

Thus, the first artist main terminal 100-1 may generate communication data CD including the selected message boxes B to E.

At this time, the generated communication data CD may include a first actual number 601 of the first artist and a second actual number 602 of the second artist.

In other words, the first artist main terminal 100-1 may detect the user input for selecting the message boxes B to E from among all messages exchanged between the first artist and the second artist, and generate the communication data CD including the selected message boxes B to E and the first actual number 601 and the second actual number 602.

Such communication data CD may be transmitted to a first artist sub-terminal 200-1 based on the input of the user (in the embodiment, the first artist) based on the first artist main terminal 100-1.

Thus, in an embodiment, the first artist sub-terminal 200-1 may receive communication data including a predetermined action selected by the first artist.

Next, in an embodiment, the artist sub-terminal 200 may transmit an approval request signal for the received communication data CD at step S103.

In detail, in an embodiment, the first artist sub-terminal 200-1 may transmit the approval request signal for the received communication data CD to at least one of a second artist main terminal 100-2, a second artist sub-terminal 200-2, and the administrator terminal 300.

The approval request signal is a predetermined signal requesting approval for converting data including conversation content into history data, and may be transmitted to at least one of the second artist main terminal 100-2, the second artist sub-terminal 200-2, and the administrator terminal 300 to request consent for disclosure of the conversation content from the first artist and the counterparty (the second artist in the embodiment) who transmits and receives the action, and to allow the administrator to review whether the conversation content may be disclosed to fans.

Further, in an embodiment, the artist sub-terminal 200 may acquire an approval signal from another terminal at step S105.

In detail, in an embodiment, the first artist sub-terminal 200-1 may acquire an approval signal from at least one of the second artist main terminal 100-2, the second artist sub-terminal 200-2, and the administrator terminal 300.

Further, in an embodiment, when the artist sub-terminal 200 obtains the approval signal from another terminal, it may perform the following step S107. When it fails to obtain the approval signal, it may return to step S101.

Next, in an embodiment, the artist sub-terminal 200 may detect the virtual number matched with the actual number at step S107.

In detail, in an embodiment, the artist sub-terminal 200 may detect the virtual number matched with the actual number of at least one artist included in the private data from the monitoring service server 500. At this time, it is assumed that at least one of the artists mentioned above is an artist who has subscribed to the monitoring service.

To this end, the monitoring service server 500 may pre-store the actual number and virtual number of each artist who has subscribed to the monitoring service.

All the virtual numbers stored in the monitoring service server 500 may be matched in advance with the actual number of the artist using the virtual number.

Turning back to FIG. 4, for example, the artist sub-terminal 200 may detect a first virtual number, “010-1234-5678,” which is matched with a first actual number 601, “010-1111-1111,” for the first artist from the monitoring service server 500.

Likewise, for example, the monitoring service server 500 may detect a second virtual number, “010-2345-6789,” which is matched with a second actual number 602, “010-2222-2222,” for the second artist from the monitoring service server 500.

That is, in an embodiment, the first artist sub-terminal 200-1 may detect the virtual numbers of the first and second artists that are matched with the actual numbers of the first and second artists included in the communication data CD from the monitoring service server 500.

Next, in an embodiment, the artist sub-terminal 200 may convert the actual number included in the received communication data CD into the detected virtual number at step S109.

In detail, in an embodiment, the first artist sub-terminal 200-1 may convert the actual numbers of the first and second artists included in the received communication data CD into the detected virtual numbers of the first and second artists.

To return to the above example, in an embodiment, the first artist sub-terminal 200-1 may convert the first actual number “010-1111-1111” included in the received communication data CD into the first virtual number “010-1234-5678”. Similarly, in an embodiment, the first artist sub-terminal 200-1 may convert the second actual number of the second artist “010-2222-2222” included in the received communication data CD into the second virtual number “010-2345-6789”.

Next, in an embodiment, the artist sub-terminal 200 may generate the private data including the virtual number at step S111.

In detail, in an embodiment, the first artist sub-terminal 200-1 may convert the actual number included in the communication data CD into the virtual number and then generate first private data that is data including the virtual number.

In an embodiment, the second artist sub-terminal 200-2 that transmits the approval signal at step S105 may also generate second private data including the virtual number by going through the above-described steps S107 to S111, just like the first artist sub-terminal 200-1.

At this time, according to an embodiment, the first private data generated in the first artist sub-terminal 200-1 and the second private data generated in the second artist sub-terminal 200-2 may be private data in which the receiver and sender are replaced from the perspectives of each terminal.

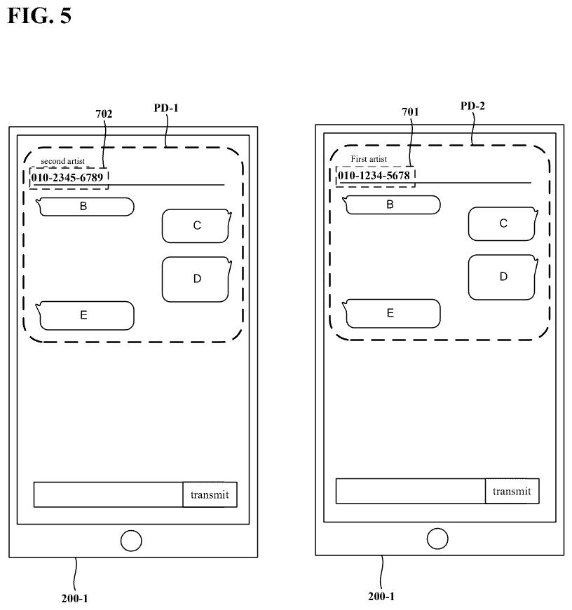

FIG. 5 shows examples of private data generated in first and second artist sub-terminals according to an embodiment of the present disclosure.

In an embodiment, the first artist sub-terminal 200-1 may generate first private data PD-1 including “010-2345-6789”, whose counterparty is the second artist and which is the virtual number 702 of the second artist.

Further, in an embodiment, the second artist sub-terminal 200-2 may generate second private data PD-2 including “010-1234-5678”, whose counterparty is the first artist and which is the virtual number 701 of the second artist.

At this time, the positions of the message boxes B to E included in the first and second private data PD-1 and PD-2 generated from the first and second artist sub-terminals 200-1 and 200-2 may be replaced according to the viewpoint of each terminal.

Thus, in an embodiment, the first artist sub-terminal 200-1 and the second artist sub-terminal 200-2 may store the first and second private data PD-1 and PD-2 generated in each terminal in the memory of each terminal.

The first and second private data may be included in the history data that is the subject of monitoring of the monitoring service to which multiple fan terminals 400 have subscribed, as the contact history content of the first artist and the contact history content of the second artist, respectively.

That is, the plurality of fan terminals 400 that have subscribed to the monitoring service for the first artist and the second artist may view history data including the first and second private data at each terminal when monitoring the first artist sub-terminal 200-1 and the second artist sub-terminal 200-2.

The artist sub-terminal 200 according to an embodiment of the present disclosure generates private data including the virtual number of each artist, so that, if an artist wishes to share content with fans while conversing with others in real life, the artist's personal information may be protected and the content may be shared immediately with the fans, thereby having the effect of quickly and safely delivering the artist's latest activity information to the fans.

Further, in an embodiment, the messenger data may be generated based on a predetermined action transmitted and received by at least two artists using the virtual numbers of their respective artist sub-terminals 200.

The messenger data is the record of multiple artists contacting each other based on their own artist sub-terminals 200, and may include group chat room conversation history, voice and video call history between multiple artists, message history, and direct message history exchanged via SNS.

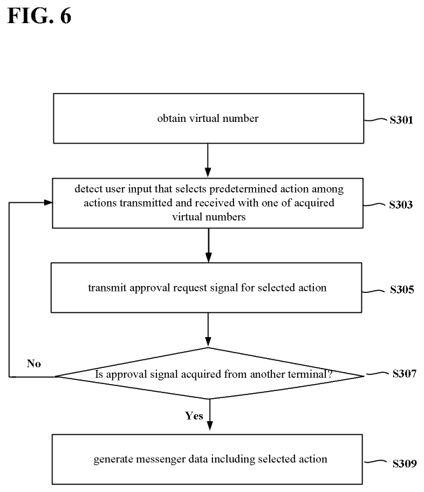

FIG. 6 is a flowchart illustrating a method for generating the messenger data according to an embodiment of the present disclosure.

Referring to FIG. 6, in an embodiment, the artist sub-terminal 200 may obtain at least one virtual number at step S301.

In detail, in an embodiment, the artist sub-terminal 200 may automatically and manually obtain at least one virtual number based on the monitoring service server 500 and user input.

At this time, at least one virtual number acquired may be a virtual number of an artist associated with the first artist using the first artist sub-terminal 200-1.

For example, the virtual number acquired by the first artist sub-terminal 200-1 may be the virtual number of a member of the same group as the first artist, a member of another group belonging to the same agency, a member of another group with whom the artist has a personal relationship, etc.

Further, in an embodiment, the artist sub-terminal 200 may automatically obtain the virtual number of at least one artist associated with the first artist based on predetermined data stored in the monitoring service server 500.

For example, in an embodiment, the first artist sub-terminal 200-1 may automatically update the virtual numbers of n artists corresponding to the same group and agency based on at least one virtual number of an artist that is stored in a matching manner with the artist name, artist group name, artist agency name, etc. in the monitoring service server 500.

Through the update, in an embodiment, the artist sub-terminal 200 may automatically obtain n artist virtual numbers associated with the first artist.

Further, in an embodiment, the artist sub-terminal 200-1 may also manually obtain at least one virtual number based on an input from an artist using the artist sub-terminal 200-1.

For example, in an embodiment, the first artist sub-terminal 200-1 may manually obtain n artist virtual numbers by performing a predetermined input for storing n artist virtual numbers based on the sub-terminal application of the first artist sub-terminal 200-1.

Further, in an embodiment, the artist sub-terminal 200 may send and receive predetermined actions to each other using the virtual number of each terminal.

Next, in an embodiment, the artist sub-terminal 200 may detect a user input that selects a predetermined action among the actions transmitted and received with one of the acquired virtual numbers at step S303.

To this end, in an embodiment, the first artist may select a predetermined action from among all actions transmitted and received between the first artist and the second artist based on the first artist sub-terminal 200-1 using their respective virtual numbers.

The selected predetermined action may be an action that includes text, captured images, recorded videos, etc. containing content that the first artist wishes to disclose to fans among records exchanging with the second to nth artists.

In other words, in an embodiment, the first artist sub-terminal 200-1 may detect the input of the first artist selecting a predetermined action among the actions performed with the second virtual number of the second artist using the second artist sub-terminal 200-2 based on the first virtual number of the artist.

Further, in an embodiment, the artist sub-terminal 200 may transmit an approval request signal for the selected action at step S305.

In detail, in an embodiment, the first artist sub-terminal 200-1 may transmit a signal requesting approval for converting the selected action into history data to at least one of the second artist sub-terminal 200-2 and the administrator terminal 300.

The approval request signal may be sent to the first artist and the other party (the second artist in this example) who sends and receives the action to ask for consent to disclose the conversation content, and allow the administrator to review whether the conversation content is disclosed to fans.

Further, in an embodiment, the artist sub-terminal 200 may acquire an approval signal from another terminal at step S307.

In detail, in an embodiment, the first artist sub-terminal 200-1 may acquire an approval signal from at least one of the second artist sub-terminal 200-2 and the administrator terminal 300.

Further, in an embodiment, when the artist sub-terminal 200 obtains the approval signal from another terminal, it may perform the following step S309. When it fails to obtain the approval signal, it may return to step S303.

Next, in an embodiment, the artist sub-terminal 200 may generate the messenger data including the selected action at step S309.

In detail, in an embodiment, the first artist sub-terminal 200-1 may generate first messenger data, which is data including the selected action and the first and second virtual numbers.

In an embodiment, the second artist sub-terminal 200-2 that transmits the approval signal at step S307 may also generate second messenger data including the first and second virtual numbers, similar to the first artist sub-terminal 200-1.

According to an embodiment, the first messenger data generated in the first artist sub-terminal 200-1 and the second messenger data generated in the second artist sub-terminal 200-2 may be messenger data in which the receiver and sender are replaced from the perspective of each terminal. The description thereof is the same as that for private data, so the description in FIG. 5 is applied thereto.

In other words, the action transmitted and received between the first and second artists are displayed with the same content regardless of which terminal is accessed between the first artist sub-terminal 200-1 and the second artist sub-terminal 200-2, and only the receiver and sender are changed.

Thus, in an embodiment, the first artist sub-terminal 200-1 and the second artist sub-terminal 200-2 may store the first and second messenger data generated in each terminal in the memory of each terminal.

The first and second messenger data may be included in the history data that is the monitoring target of the monitoring service to which multiple fan terminals 400 have subscribed, as the contact history content of the first artist and the contact history content of the second artist, respectively.

That is, the plurality of fan terminals 400 that have subscribed to the monitoring service for the first and second artists may view history data including the first and second messenger data on each terminal when monitoring the first artist sub-terminal 200-1 and the second artist sub-terminal 200-2.

The artist sub-terminal 200 according to an embodiment of the present disclosure generates messenger data including actions sent and received between virtual numbers of each artist, thereby completely preventing the artist's personal phone number from being leaked, while also increasing intimacy with fans by disclosing conversations that the artist has with other artists in their daily lives.

Further, in an embodiment, the artist sub-terminal 200 may receive and store scenario content included in the history data.

In an embodiment, the scenario content may be content including a virtual contact record created by an administrator and scenario planner using the administrator terminal 300.

In detail, in an embodiment, the scenario content may be different from the contact record content described above in that it is the virtual contact record of the artist created by the scenario planner rather than a contact record based on the artist's actual interactions.

In other words, in an embodiment, the scenario content may be data generated based on the direction of the scenario planner, such as conversation parties (e.g., message recipients and senders, etc.) who exchange a predetermined action and conversation content, unlike the private data and the messenger data that are based on actions actually performed by the artist.

The scenario content may include information such as call start and end times, call recording audio files, message receiving and sending times, message conversation content, and conversation party names (e.g., own name, call recipient name, and message recipient name).

At least one scenario content may be generated in another terminal and/or another server, including the administrator terminal 300 and the monitoring service server 400, and transmitted to the artist sub-terminal 200 and stored in the artist sub-terminal 200. Hereinafter, for convenience of explanation, the scenario content is described based on the example in which it is generated at the administrator terminal (300) and transmitted to the artist sub terminal (200).

According to various embodiments, the artist sub-terminal 200 may receive 1) scenario content in which the conversation parties and conversation content of the scenario are already specified and/or 2) scenario content in which the conversation parties of the scenario are not specified and only the conversation content is included.

In an embodiment, the first artist sub-terminal 200-1 may receive scenario content in which 1) the conversation parties and conversation content of the scenario are already specified.

At this time, the conversation parties (e.g., the first artist and the second artist) and the conversation content that exchange at least one action included in the scenario content in an embodiment may be set by the scenario planner.

In an embodiment, the first artist sub-terminal 200-1 may store the scenario content, which is received from the administrator terminal 300 and in which the first artist is included as the conversation party, in the memory of the first artist sub-terminal 200-1.

At this time, the first artist sub-terminal 200-1 may store an action corresponding to the virtual number of the first artist sub-terminal 200-1 in the scenario content as a transmitted action record, and store an action corresponding to the virtual number of the second artist sub-terminal 200-2 as a received action record, so that they may be saved as if the first artist and the second artist exchanged actions through the terminals.

Further, in an embodiment, the second artist sub-terminal 200-2 may store the scenario content, which is received from the administrator terminal 300 and in which the second artist is included as the conversation party, in the memory of the second artist sub-terminal 200-2.

At this time, the second artist sub-terminal 200-2 may store an action corresponding to the virtual number of the first artist sub-terminal 200-1 in the scenario content as a received action record, and store an action corresponding to the virtual number of the second artist sub-terminal 200-2 as a transmitted action record, so that they may be saved as if the first artist and the second artist exchanged actions through the terminals.

Such scenario content may be included in the history data that is subject to monitoring by the multiple fan terminals 400 that have subscribed to the monitoring service for the first and second artists.

In another embodiment, the artist sub-terminal 200 may store the scenario content, which is received from the administrator terminal 300 and in which the conversation party is not specified, in the memory of the artist sub-terminal 200.

Further, in another embodiment, the artist sub-terminal 200 may transmit the scenario content in which the conversation party is not specified to at least one fan terminal 400.

Furthermore, in another embodiment, unspecified conversation parties (e.g., recipient and sender) may be set by user input of the fan terminal 400 and provided as history data to the fan terminal 400.

That is, the scenario content according to another embodiment may be included in history data that is the target of the monitoring service used by the fan terminal 400 by designating a plurality of artists selected according to user input of the fan terminal 400 as conversation parties of the scenario content, and details thereof will be described later in the method for providing the monitoring service by the fan terminal 400.

Further, in an embodiment, the artist sub-terminal 200 may create and store artist content included in the history data.

In detail, in an embodiment, the artist sub-terminal 200 may generate and store at least one artist content based on the user input using the artist sub-terminal 200.

The above artist content may include information about the artist created directly by the artist, such as images and videos, schedules, E-mails, music playlists, and certain SNS subscription lists related to the artist.

To this end, in an embodiment, the artist sub-terminal 200 may perform photographing based on an image sensor to obtain images and/or videos related to the artist.

In addition, for example, in the embodiment, the artist sub-terminal 200 may detect user input based on a predetermined platform installed in the artist sub-terminal to generate and obtain the artist's music playlist and SNS subscription list, etc.

That is, in an embodiment, the artist sub-terminal 200 may generate and store artist content including at least one acquired data.

To summarize, in an embodiment, the artist sub-terminal 200 may store history data including contact record content and artist content including at least one private data and messenger data generated in the artist sub-terminal 200, and at least one scenario content received from the administrator terminal 300.

Further, the history data stored in the artist sub-terminal 200 may be provided to the fan terminal 400, so that the fan terminal 400 may use the monitoring service to check, view, play, and listen to the history data based on an installed fan terminal-only application.

Method of providing Monitoring Service in Fan Terminal 400

Hereinafter, the method of providing the monitoring service by the application for the fan terminal executed by at least one processor of the fan terminal 400 according to an embodiment of the present disclosure is described in detail.

In an embodiment of the present disclosure, at least one processor of the fan terminal 400 may execute at least one fan terminal application stored in the memory of at least one fan terminal 400 or operate it in the background.

Hereinafter, the method of providing the above-described monitoring service by having at least one processor of the fan terminal 400 operate to execute commands of the at least one fan terminal application will be briefly described as being performed by the fan terminal 400.

In an embodiment, the fan terminal 400 may perform at least one action.

In detail, in an embodiment, the fan terminal 400 may perform at least one action on the artist's virtual number.

To this end, in an embodiment, the fan terminal 400 may obtain a virtual number of an artist by subscribing to the monitoring service of the favorite artist (e.g., purchasing/paying for a ticket or subscription, etc.) based on the fan terminal application installed in the fan terminal 400.

For example, the ticket for subscribing to the monitoring service may include information on the artist virtual number and the amount charged for each action, and at least one ticket may be purchased for each artist the fan supports.

Further, in an embodiment, the fan terminal 400 may perform predetermined actions, including phone calls, text messages, and voice messages, with respect to the acquired virtual number of the artist.

At this time, since the fan terminal 400 is an action performed through a phone number, the action may be performed through a separate application for performing actions such as the terminal's basic phone call, text message, and SNS application, rather than a separate fan terminal application.

Further, in an embodiment, the fan terminal 400 may incur communication fees based on the number of actions performed on the artist's virtual number on the fan terminal 400.

That is, separately from the monitoring service, the fan terminal 400 may incur communication fees charged by the communication company for each action corresponding to the virtual number, and may incur an additional fee when taking an action for the virtual number.

For example, if the fan terminal 400 according to an embodiment purchases a ticket including information on the amount charged at 500 won per phone call and 1,000 won per text message, and sends 10 phone calls and 10 text messages for the acquired artist virtual number, the fan terminal 400 may pay an amount of 10*500+10*1,000=15,000 won.

Further, in another embodiment, the fan terminal 400 may pay a fee for a ticket that has a preset maximum number of actions that may be sent to the artist's virtual number from the fan terminal 400.

At least a certain percentage of the communication charges for actions that occur in this way may be settled and transferred to the party operating the monitoring service.

Further, in an embodiment, the fan terminal 400 may monitor the history data stored in the artist sub-terminal 200.

In detail, in an embodiment, the fan terminal 400 may monitor the history data stored in the artist sub-terminal 200 of the artist who is the target of the monitoring service.

The above history data may include contact history content, artist content and scenario content including at least one private data, messenger data and action data. In an embodiment, the fan terminal 400 may monitor schedules, photos, music playlists, text messages and E-mail contents, etc. according to the history data stored in the artist sub-terminal 200.

At this time, in an embodiment, the fan terminal 400 may perform a partial additional payment to use additional services such as viewing the saved photo on a large screen or listening to music from the saved playlist for 30 seconds.

Meanwhile, in an embodiment, the fan terminal 400 may filter at least one action data included in the contact record content of the history data. Hereinafter, it is described that the fan terminal 400 receives the history data stored in the artist sub-terminal 200 and then filters and provides it, but the server 500 or the artist sub-terminal 200 may first filter and provide the history data to correspond to the fan terminal 400.

In an embodiment, the action data may mean data in which at least one fan terminal 400 performs a predetermined action, including a phone call, text message, or voice message, to the virtual number of the artist sub-terminal 200 through a basic application installed in each fan terminal 400. Further, the action data may further include data indicating that the artist has performed a predetermined action sent to the fan terminal 400 via the virtual number.

At this time, in an embodiment, the fan terminal 400 may detect the action data so that among the entire action data performed by the artist sub-terminal 200, only the action transmitted by the user of the fan terminal 400 and the content fed back by the artist sub-terminal 200 are exposed.

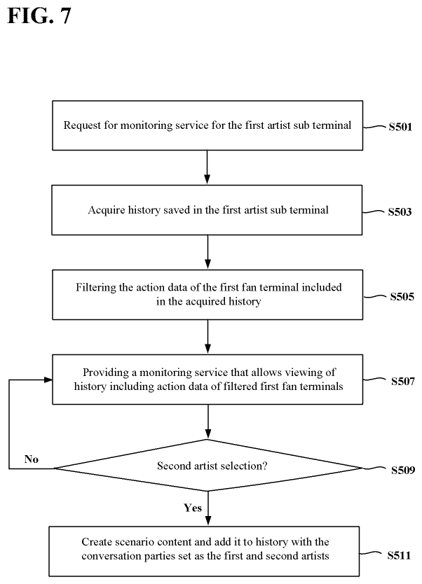

FIG. 7 is a flowchart illustrating a method for detecting action data according to an embodiment of the present disclosure.

Referring to FIG. 7, in an embodiment, the fan terminal 400 may request the monitoring service for the first artist sub terminal 200-1 at step S501.

In detail, in an embodiment, the fan terminal 400 may request the monitoring service for the first artist sub-terminal 200-1 among at least one artist's monitoring service that has subscribed. At this time, the fan terminal 400 may be the fan terminal 400 that has performed at least one action on the virtual number of the first artist obtained by subscribing to the monitoring service for the first artist.

To this end, in an embodiment, the fan terminal 400 may perform a user input requesting the monitoring service for the first artist among at least one artist's monitoring service that has subscribed based on the application for the fan terminal.

Next, in an embodiment, the fan terminal 400 may obtain the history data stored in the first artist sub-terminal 200-1 according to at least one user input performed above at step S503.

In an embodiment, at least one action data included in the acquired history data may include actions performed by fans supporting the first artist toward the virtual number of the first artist based on their respective fan terminals 400. At this time, the action data may also include action data performed by the first fan, who is a user of the first fan terminal 400-1.

Further, in an embodiment, the fan terminal 400 may detect action data of the first fan terminal included in the acquired history data at step S505.

In detail, in an embodiment, the fan terminal 400 may detect action data of the first fan terminal 400-1, which is a fan terminal owned and used by the user, in order to view only the actions performed by the user among at least one action data included in the acquired history data.

At this time, in an embodiment, the fan terminal 400 may detect action data transmitted from one specific fan terminal 400 based on unique information (e.g., phone number and fan account ID, etc.) included in each fan terminal 400.

In the following, for convenience of explanation, the description is based on detecting a predetermined action data based on the unique phone number of the fan terminal 400.

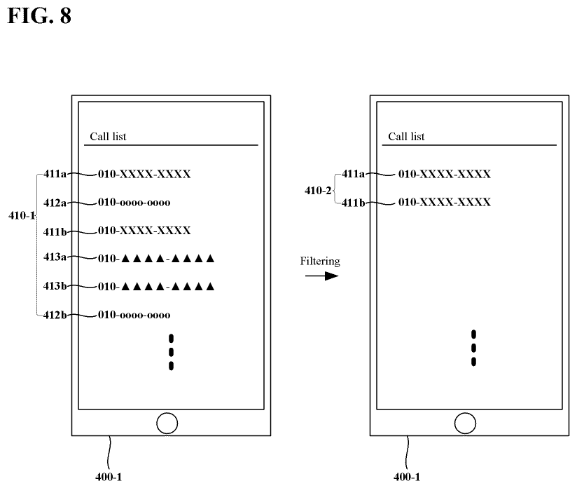

FIG. 8 is an example showing a method for detecting action data according to an embodiment of the present disclosure.

Referring to FIG. 8, in an embodiment, the first fan terminal 400-1 may detect only the action data performed by the first fan terminal 400-1 among at least one action data included in the acquired history data.

To this end, in an embodiment, the fan terminal 400 may extract only the entire action data 410-1 performed by the first artist sub-terminal 200-1 from at least one fan terminal among the contact record content of the history data for the acquired first artist sub-terminal 200-1.

At this time, the entire extracted action data 410-1 may include a unique phone number used by each fan terminal.

For example, as illustrated in FIG. 8, the entire extracted action data (410-1) may include first to third fan phone numbers (“010-XXXX-XXXX”, “010-○○○○-○○○○” and “010-ΔΔΔΔ-ΔΔΔΔ”) used by the first to third fan terminals, respectively.

In addition, for example, the entire extracted action data 410-1 may include a plurality of action data 411a and 411b performed with the first fan phone number, a plurality of action data 412a and 412b performed with the second fan phone number, and a plurality of action data 413a and 413b performed with a third fan phone number.

Further, in an embodiment, the fan terminal 400 may compare the unique phone number of at least one fan terminal included in the extracted entire action data 410-1 with the first fan phone number pre-stored in the memory of the first fan terminal 400-1.

Thus, in an embodiment, the fan terminal 400 may detect only the action data 410-2 matched with the first fan phone number among the entire extracted action data 410-1.

That is, in an embodiment, the first fan terminal 400-1 may sort only the predetermined action data performed by the first fan terminal 400-1 among the entire action data 410-1 performed by the first artist sub-terminal 200-1 based on the unique phone number of each fan terminal 400.

For example, in an embodiment, the first fan terminal 400-1 may sort only the action data 411a and 411b performed by the first fan terminal 400-1 based on the first fan phone number “010-XXXX-XXXX” among the entire action data 410-1. Hereinafter, for convenience of explanation, the sorted action data may be collectively referred to as filtering action data 410-2.

Therefore, the filtering action data 410-2 may include action data corresponding to the number of actions performed by the first artist sub-terminal 200-1 using the first fan phone number.

Further, in an embodiment, the first fan terminal 400-1 may add private data and messenger data included in the contact record content of the acquired history data to the filtering action data 410-2.

In other words, in an embodiment, the first fan terminal 400-1 may provide data (hereinafter referred to as filtered data FD) excluding action data received from another fan terminal 400 among the contact record contents as the history data of the first artist sub-terminal 200-1 to the first fan terminal 400-1 as the monitoring service.

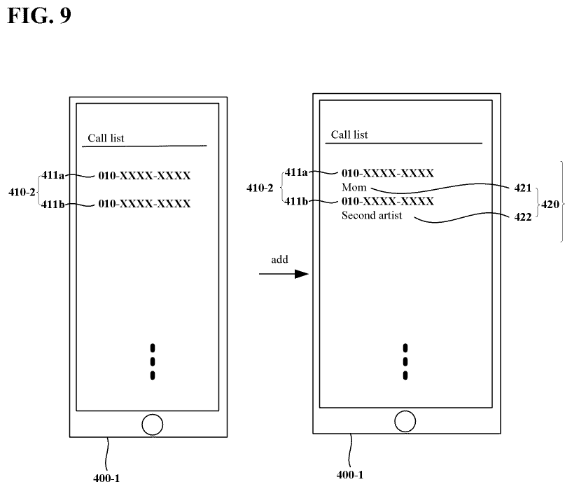

FIG. 9 is an example showing a method for generating filtering data according to an embodiment of the present disclosure.

Referring to FIG. 9, in an embodiment, the first fan terminal 400-1 may add contact record data 420 included in the contact record content of the acquired history data to the filtering action data 410-2 to generate filtering data FD.

At this time, the contact record data 420 may be one of the private data and messenger data included in the contact record content.

For example, as shown in the drawing, the predetermined data 420 may include first private data 421 which is a record of a call between the first artist and his or her mother based on the actual number, and first messenger data 422 which is a record of a call between the first artist and the second artist based on the virtual number.

Further, in an embodiment, the fan terminal 400 may list data included in the filtering data FD in chronological order to provide an effect in which the filtering data FD including the filtering action data 410-2 and the contact record data 420 appears like an actual call list.

That is, in an embodiment, the first fan terminal 400-1 may filter the action data of the first fan terminal 400-1 included in the acquired history data by generating the filtering data FD in which the filtering action data 410-2 and the contact record data 420 are listed in chronological order.

Further, in an embodiment, the fan terminal 400 may provide a monitoring service that may view history data including the filtered action data of the first fan terminal at step S507.

In detail, in an embodiment, the first fan terminal 400-1 may provide the monitoring service for the first artist sub-terminal 200-1 that may view the history data including the filtering data FD based on a fan terminal application IA-400.

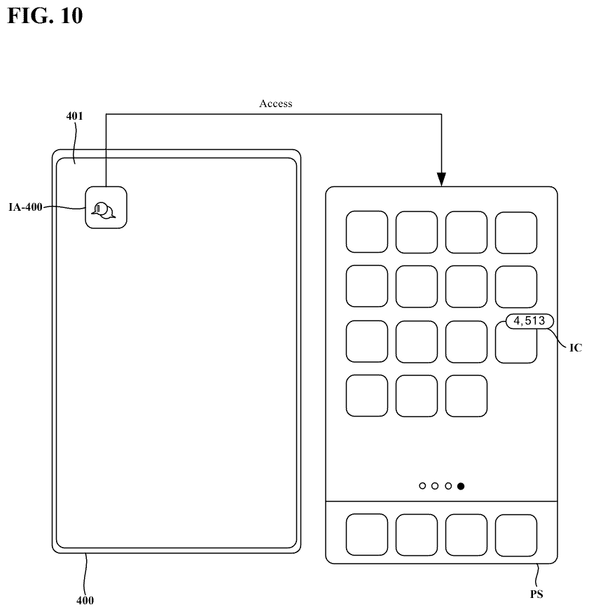

FIG. 10 is an example showing a monitoring service provided to a fan terminal according to an embodiment of the present disclosure.

Referring to FIG. 10, in an embodiment, the fan terminal 400 may provide the monitoring service for the first artist sub-terminal 200-1 to the user of the fan terminal 400 based on the fan terminal application IA-400.

In an embodiment, the fan terminal 400 may detect a predetermined user input to connect to the fan terminal application IA-400 and provide the monitoring service.

Further, in an embodiment, the fan terminal 400 may provide the monitoring service to the user of the fan terminal 400 by displaying a screen (hereinafter, “private screen PS)” that is identical to a screen of the first artist sub-terminal 200-1 on the display 401 of the fan terminal 400 in order to perform a production that appears to be peeking at the screen of the first artist sub-terminal 200-1 based on the monitoring service.

To this end, in an embodiment, the fan terminal 400 may update the history data of the first artist sub-terminal 200-1 based on the time at which the monitoring service for the first artist sub-terminal 200-1 is requested.

Further, in an embodiment, the fan terminal 400 may provide the updated history data of the first artist sub-terminal 200-1 to the user of the fan terminal 400 through the private screen PS on the display 401. Thus, the user of the fan terminal 400 may view the history data of the first artist sub-terminal 200-1 by operating a predetermined application included in the private screen PS.

For example, in an embodiment, the fan terminal 400 may check the schedule stored in the artist sub-terminal 200, view and play certain content including photos and videos, play and listen to a music playlist, and view text and E-mail content based on the fan terminal application IA-400.

At this time, the history data of the first artist sub-terminal 200-1 exposed on the display 401 through the private screen PS may include contact record content, scenario content, and artist content including the filtering data FD.

Further, in an embodiment, the fan terminal 400 may display content that the user of the fan terminal 400 has not read based on a predetermined notification icon.

Turning back to FIG. 10, in an embodiment, the fan terminal 400 may display at least one piece of content accumulated during a period when the user is not connected to the monitoring service based on the fan terminal application IA-400 using a predetermined notification icon IC.

The notification icon IC is placed on one side of at least one application icon and may include a number corresponding to accumulated data.

Further, the notification icon IC may be deactivated when the user of the fan terminal 400 has viewed all the content.

Further, in an embodiment, the fan terminal 400 may provide as the monitoring service the creation and reception time of data constituting the content included in the history data of the first artist sub-terminal 200-1, the phone number and name of the terminal that transmits the data, and the data content.

For example, when a user accesses a “Message” application included in the private screen PS based on the fan terminal application IA-400 of the first fan terminal 400-1, the first fan terminal 400-1 may monitor the contents including the creation and reception time of the message transmitted to the first artist sub-terminal 200-1, the phone number and name of the person who transmits the message, the contents of the message, etc.

At this time, the user may distinguish which terminal the message is sent from based on the phone number and name of the other party who sends the message included in the content.

That is, action data performed by the user may be exposed as his or her phone number and nickname, and data performed by someone other than the user and exposed as history data may be exposed as a predetermined virtual number or a name designated by the artist.

Further, in an embodiment, the fan terminal 400 may detect a second artist selection input based on the monitoring service at step S509

In detail, in an embodiment, the fan terminal 400 may detect an input for selecting a second artist, who is a virtual contact of the first artist, who is a user of the first artist sub-terminal 200-1, to create the scenario content.

At this time, the counterparty may be an artist other than the first artist among the artists registered for the monitoring service, and there may be multiple second to nth artists, not just one second artist. However, for the convenience of explanation, the explanation will be based on the assumption that there is one second artist.

In an embodiment, a first fan using the first fan terminal 400-1 may not select the second artist. In this case, in an embodiment, the fan terminal 400 may return to step S507 since there is no need to generate scenario content between the first and second artists. That is, in an embodiment, the fan terminal 400 may perform step S509 to create a virtual contact record between the first and second artists.

The first fan who selects the second artist may be a fan who likes the chemistry (word referring to harmony or mutual breathing between people) between the first and second artists, so that the second artist may be selected autonomously to suit the first fan's taste.

Further, the second artist may be manually selected by the first fan, or may be automatically/randomly selected by the first fan terminal 400-1. For convenience of explanation, the following description is based on the case where the second artist is manually selected by the user.

For example, in an embodiment, the fan terminal 400 may detect a user input selecting “Artist A” as the second artist.

Further, in an embodiment, the fan terminal 400 may generate scenario content in which the conversation parties are set as the first and second artists and add the generated scenario content to the history of the first and second artists at step S511.

In detail, in an embodiment, the fan terminal 400 may generate scenario content by setting the unspecified conversation parties of the scenario content stored in the first artist sub-terminal 200-1 as the first and second artists, and add the generated scenario content to the history of the first and second artists.

For example, if the first artist who is the target of the monitoring service subscribed to by the first fan is “Artist A” and the second artist selected by the user input of the first fan is “Artist B”, in an embodiment, the first fan terminal 400-1 may set the parties of the scenario content, which is pre-stored in the first artist sub-terminal 200-1 and in which the conversation parties are not specified, to “Artist A” and “Artist B”.

Further, in an embodiment, the fan terminal 400 may add scenario content in which the conversation parties are set as the first and second artists to the history data pre-stored in the first artist sub-terminal 200-1.

Further, in an embodiment, the fan terminal 400 may also monitor action data performed by at least one other fan on the artist sub-terminal 200 based on each fan terminal 400.

At this time, the at least one other fan may be a friend or acquaintance of the user of the fan terminal 400.

That is, the fan terminal 400 according to the embodiment of the present disclosure has the effect of strengthening a bond between fans who support the same artist by allowing other fans to view predetermined actions performed by the artist sub-terminal 200 on the fan terminal 400.

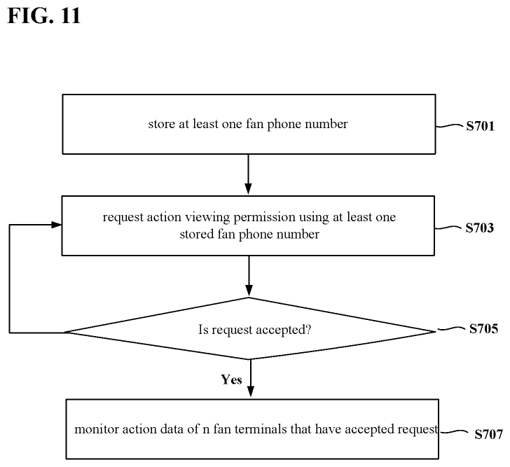

FIG. 11 is a flowchart illustrating a method in which a fan terminal monitors action data transmitted from another fan terminal according to an embodiment of the present disclosure.

Referring to FIG. 11, in an embodiment, the fan terminal 400 may store at least one fan phone number at step S701

In detail, in an embodiment, the fan terminal 400 may store fan phone numbers used by at least one other fan terminal 400 based on the fan terminal application IA-400.

In an embodiment, the fan phone number may be the phone number of another fan terminal 400 using the monitoring service.

Further, in an embodiment, the fan terminal 400 may obtain and store the fan phone number through direct input by the user of the fan terminal 400 based on the fan terminal application IA-400 and input for synchronizing the phone number of the monitoring service user among multiple phone numbers pre-stored in the memory of the fan terminal 400.

Further, in an embodiment, the fan terminal 400 may request action viewing permission using at least one stored fan phone number at step S703

In detail, in an embodiment, the fan terminal 400 may request the action viewing permission using at least one stored fan phone number based on the user input of the fan terminal 400.

For example, if it is assumed that the user of the fan terminal 400 has stored the first to nth fan phone numbers, in an embodiment, the fan terminal 400 may request action viewing permission for all and/or part of the first to nth fan phone numbers based on the user input of the fan terminal 400.

At this time, in an embodiment, the fan terminal 400 may request action viewing permission by providing a predetermined notification (e.g., a pop-up window, etc.) to the fan terminal application IA-400 installed in each of the first to third fan terminals, which are other fan terminals, by the user of the fan terminal (400) who wishes to request permission.

Thus, each of the first to third fan terminals, which are other fan terminals, may transmit a response to the request for permission to view the action by performing an acceptance or rejection input for a predetermined notification received based on the fan terminal application IA-400 installed in each terminal.

Further, in an embodiment, the fan terminal 400 may determine whether to accept the request at step S705.

In detail, in an embodiment, the fan terminal 400 may determine whether to accept the request based on the response received from the fan terminal application IA-400 installed in each of the first to third fan terminals.

In an embodiment, the fan terminal 400 may proceed to step S707 if an acceptance response is received, and may return to step S703 if a rejection response is received.

Further, in an embodiment, the fan terminal 400 may monitor the action data of n fan terminals that have accepted the request at step S707.

In detail, in an embodiment, the fan terminal 400 may monitor action data of the first to nth fan terminals that have accepted the request based on the fan terminal application IA-400.

Further, in an embodiment, the fan terminal 400 may detect a user input for selecting at least one fan terminal among the actions of the first to nth fan terminals that accept the request.

Thus, in an embodiment, the fan terminal 400 may monitor only the action data of the fan terminal that the user of the fan terminal 400 wants to view among the actions of the first to nth fan terminals that accept the request.

That is, the action data of at least one other fan terminal that may be viewed through the above-described procedure may be included in the contact record content including the filtering data FD and provided to the fan terminal 400 as the private screen PS together with at least one of the scenario content and the artist content.

As described above, the method and system for providing a monitoring service for viewing history data stored in an artist's terminal according to an embodiment of the present disclosure have the effect of easily and quickly converting personal contact records that the artist wishes to make public into content by providing the artist's actual personal contact records as content, thereby increasing temporal/procedural efficiency.

Further, the method and system for providing a monitoring service for viewing history data stored in an artist's terminal according to an embodiment of the present disclosure have the effect of satisfying the needs of fans who want personal communication with artists by performing personal/direct communication with fans based on virtual numbers.

Further, the method and system for providing a monitoring service for viewing history data stored in an artist's terminal according to an embodiment of the present disclosure have the effect of providing an indirect experience for individual fans to directly control an artist's mobile phone by remotely controlling an artist's sub-terminal to view content.

Further, the method and system for providing a monitoring service for viewing history data stored in an artist's terminal according to an embodiment of the present disclosure have the effect of improving fan satisfaction with provided content by virtually creating a contact record between multiple artists that suits the tastes of fans.

Further, the method and system for providing a monitoring service for viewing history data stored in an artist's terminal according to an embodiment of the present disclosure have the effect of increasing a fan's intimacy with an artist by providing an indirect experience as if privately interacting with the artist by detecting a contact record between the fan and the artist.

Further, the method and system for providing a monitoring service for viewing history data stored in an artist's terminal according to an embodiment of the present disclosure have the effect of forming a bond between fans who support the same artist by allowing them to view records of other fans contacting them about the artist they support.

The above-described embodiments of the present disclosure may be implemented in the form of program commands that may be executed through various computer components and recorded on a computer-readable recording medium. The above computer-readable recording medium may include program commands, data files, data structures, etc., alone or in combination. The program commands recorded on the computer-readable recording medium may be specially designed and configured for the present disclosure or may be known and available to those skilled in the art in the computer software field. Examples of the computer-readable recording medium include a magnetic medium such as hard disk, floppy disk, and magnetic tape, an optical recording medium such as CD-ROM and DVD, a magneto-optical medium such as a floptical disk, and a hardware device specifically configured to store and execute program instructions, such as ROM, RAM, and flash memory. Examples of the program instructions include not only machine language code, such as that produced by a compiler, but also high-level language code that can be executed by a computer using an interpreter, etc. The hardware device may be modified with one or more software modules to perform processing according to the present disclosure, and vice versa.

### INDUSTRIAL APPLICABILITY

Since the present disclosure relates to a method for providing a monitoring service that allows fans to view history stored in an artist's terminal using individual terminals owned and used by each fan, it has industrial applicability.

What is claimed is:

1. A method for providing a monitoring service in which a fan terminal application executed by at least one processor of a fan terminal views history data stored in a terminal of a first artist, the method comprising:
transmitting at least one action to a virtual number of the first artist terminal;
executing the monitoring service that displays the history data stored in the first artist terminal;
receiving the history data stored in the first artist terminal;
detecting action data corresponding to the fan terminal among action data included in the received history data; and
providing the history data including the detected action data according to a user's selection.

2. The method of claim 1, wherein the virtual number is a telephone number of an artist's sub-terminal that is a subject of the monitoring service.

3. The method of claim 1, wherein:
the action means at least one of a phone call, text message, and voice message sent by the fan terminal to the virtual number, and
the action data is contact record data stored in the artist terminal according to the action of the fan terminal.

4. The method of claim 1, wherein the providing the history data according to the user's selection comprises:
viewing the history data of the first artist terminal by operating a predetermined application included in a screen based on a screen that displays the same screen as the screen of the first artist terminal on a display of the fan terminal.

5. The method of claim 1, wherein the detecting the action data corresponding to the fan terminal among the action data included in the received history data comprises:
detecting only action data corresponding to a unique phone number of the fan terminal from the action data stored in the first artist terminal according to actions performed on a plurality of fan terminals.

6. The method of claim 1, wherein the received history data comprises messenger data that stores content of action exchanged between the first artist terminal and the second artist terminal based on respective virtual numbers.

7. The method of claim 1, wherein the providing the history data including the detected action data according to the user's selection comprises:
executing a view of the contact record of the first artist; and
controlling display of messenger data, which is a contact record with the second artist.

8. The method of claim 1, wherein:
the received history data comprises scenario content that is a virtual contact record between the first and third artists transmitted from the administrator terminal,
the providing the history data according to the user's selection comprises:
executing a view of the contact record of the first artist; and
controlling display of scenario content, which is a contact record with the third artist.

9. The method of claim 1, wherein:
the received history data further comprises artist content including at least one of an image, video, schedule, E-mail, playlist, and SNS subscription list generated according to the input of the first artist in the first artist terminal, and
the providing the history data according to the user's selection comprises:
executing a view of the image included in the artist content; and
controlling a display of the image stored in the artist content.

10. The method of claim 1, wherein the detecting the action data corresponding to the fan terminal among the action data included in the received history data comprises:
storing a first fan phone number of the first fan terminal;
requesting action viewing permission with the stored first fan phone number; and
adding the action data performed by the first fan terminal for the first artist terminal to the history data and providing it as a viewable monitoring service, when the request is accepted.

11. A system for providing a monitoring service for viewing history data stored in an artist's terminal, the system comprising:
at least one fan terminal with a fan terminal application installed;
an artist sub-terminal with a registered virtual number;
an administrator terminal in which an application for an administrator terminal is installed; and
a monitoring service server that communicates with at least one fan terminal, artist sub-terminal, and administrator terminal using a network,
wherein the fan terminal application performs at least one action with the virtual number of the first artist sub-terminal,
executes an application that provides a monitoring service for the first artist sub-terminal,
obtains history data stored in the first artist sub-terminal, and
controls the display of the obtained history data according to the user's viewing input.
